(19) United States
(12) Patent Application Publication
(10) Pub. No.: US 2013/0346127 A1
(43) Pub. Date: Dec. 26, 2013

(54) SITE MAPPING SYSTEM HAVING TOOL LOAD MONITORING

(71) Applicant: Jeffrey E. JENSEN, Dunlap, IL (US)

(72) Inventor: Jeffrey E. JENSEN, Dunlap, IL (US)

(21) Appl. No.: 13/530,715

(22) Filed: Jun. 22, 2012

(51) Int. Cl. G06F 7/00; G06Q 10/06

(52) U.S. Cl. 705/7.12; 701/50; 705/306; 701/1

(57) ABSTRACT

A site mapping system for use with a machine having a work tool is disclosed. The site mapping system may have a locating device mountable on the machine and configured to generate a first signal associated with a three-dimensional position of the machine at the site, at least one sensor mountable on the work tool and configured to generate a second signal indicative of a characteristic of material being moved by the work tool, and a controller in communication with the locating device and the at least one sensor. The controller may be configured to determine a composition of the material based on the second signal. The controller may also be configured to update an electronic map of the site based on the composition and the first signal.

### TECHNICAL FIELD

The present disclosure relates generally to a mapping system, and more particularly, to a site mapping system having tool load monitoring.

### BACKGROUND

Profitability of a worksite, for example of a mine site, depends on a number of factors over which site operators have control. Specifically, profitability can be affected by knowledge about mineral deposits at the site and by the deployment of resources used to collect the deposits. If the knowledge about the mineral deposits is lacking or inaccurate, the resources cannot be efficiently and productively deployed to collect the deposits.

A common way to gain knowledge about mineral deposits is to survey the worksite and collect mineral samples at the surveyed locations. This information can then be used to generate a map of the worksite, and resources can be selectively deployed to mineral-rich areas that are marked on the map. By avoiding areas that are mineral-poor and concentrating efforts and resources on only those areas believed to be rich in minerals, the profitability of the worksite can be increased.

Although adequate for some applications, the process described above can also be problematic. In particular, surveying a worksite can be time consuming and expensive. For this reason, the survey work is often used sparingly with a limited number of locations being surveyed and sampled. General assumptions about the entire worksite are then made based on this limited input and, unfortunately, the assumptions are often inadequate or incorrect. In this situation, the profitability of the worksite is proportional to the quality of the assumptions made about the worksite.

The disclosed site mapping system is directed to overcoming one or more of the problems set forth above and/or other problems of the prior art.

### SUMMARY

One aspect of the present disclosure is directed to a site mapping system for use with a machine having a work tool. The site mapping system may include a locating device that is mountable on the machine and configured to generate a first signal associated with a three-dimensional position of the machine at a site, at least one sensor that is mountable on the work tool and configured to generate a second signal indicative of a characteristic of material being moved by the work tool, and a controller in communication with the locating device and the at least one sensor. The controller may be configured to determine a composition of the material based on the second signal. The controller may also be configured to update an electronic map of the site based on the composition and the first signal.

Another aspect of the present disclosure is directed to a method of mapping a worksite. The method may include determining a three-dimensional location of a machine operating at the worksite, and sensing a characteristic of material being moved by a work tool of the machine. The method may also include determining a composition of the material based on the characteristic, and updating an electronic map of the worksite based on the composition of the material and the location of the machine.

### BRIEF DESCRIPTION OF THE DRAWINGS

FIG. 1 is a diagrammatic illustration of an exemplary disclosed machine; and

FIG. 2 is a schematic illustration of an exemplary disclosed mapping system that may be used with the machine of FIG. 1.

### DETAILED DESCRIPTION

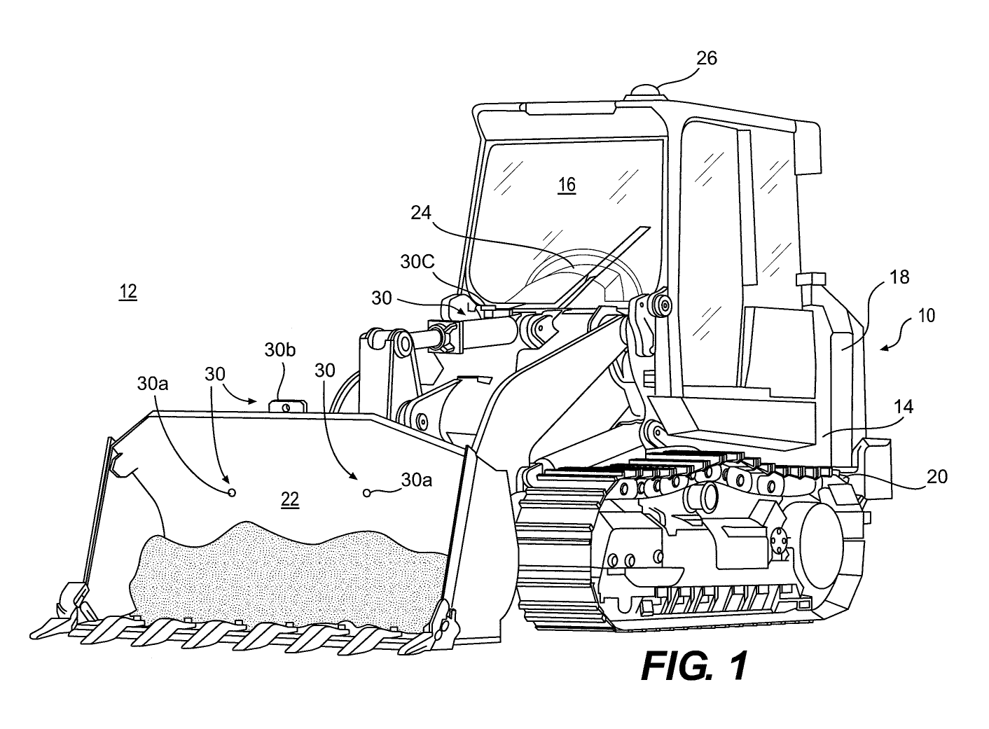

FIG. 1 illustrates an exemplary machine 10 operating at a worksite 12. Machine 10 may be a mobile machine that performs some type of operation associated with an industry such as mining, construction, farming, transportation, or any other industry known in the art. Exemplary operations include, among others, carrying, digging, dozing, hauling, ripping, scraping, etc. Accordingly, machine 10 may be an earth moving machine such as a carry dozer (shown in FIG. 1), a scraper, an agricultural tractor, a wheel loader, a haul truck, or another machine known in the art that is configured to move earthen material at worksite 12. Machine 10 may generally include a frame 14 that at least partially defines or supports an operator station 16, one or more engines 18 mounted to frame 14, a plurality of traction devices 20 driven by engine 18 to propel machine 10, and a work tool 22 operatively connected to frame 14 and powered by engine 18.

Operator station 16 may be equipped with one or more interface devices 24 located proximate an operator seat (not shown) and configured to exchange information (e.g., performance data, worksite records, control commands, etc.) with an operator of machine 10. These interface devices 24 may include, among other things, a monitor, a joystick, a pedal, a keypad, a lever, and/or any other device known in the art. Interface devices 24 may be configured to generate and receive signals corresponding with the information exchange.

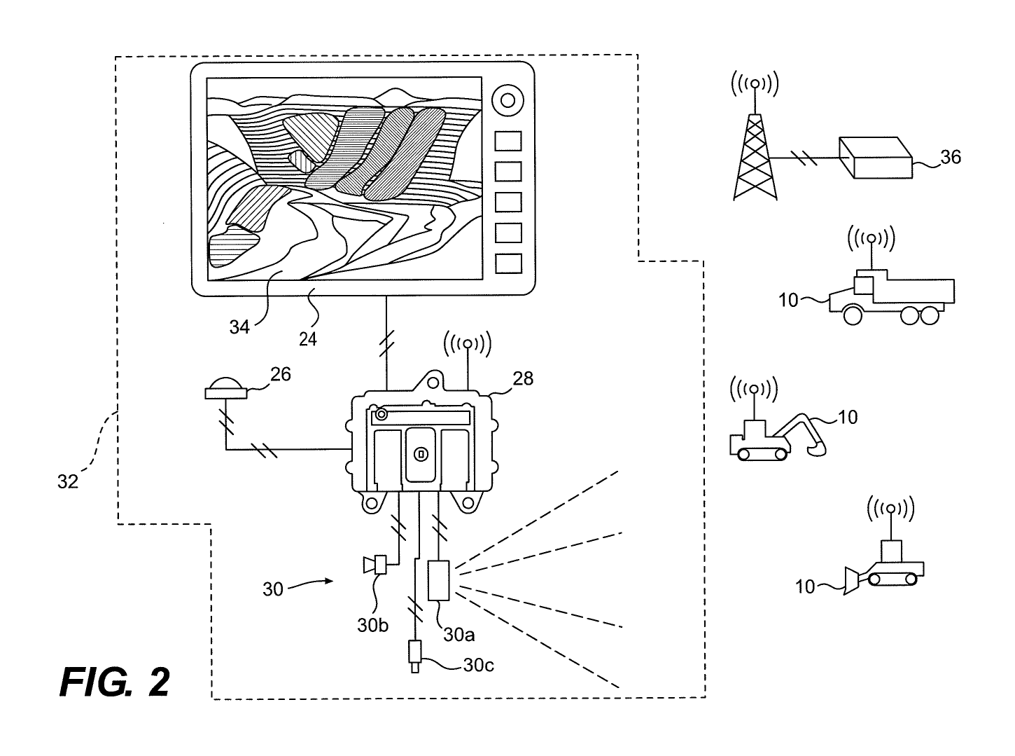

In the exemplary embodiment of FIGS. 1 and 2, one of interface devices 24 includes a monitor that provides a graphics user interface (GUI) for presentation of worksite information. The monitor may be a computer console or cab-mounted monitor, an LCD screen, a plasma screen, or another similar device that receives instructions and displays corresponding information. It is contemplated that the monitor may also be configured to receive input from the operator regarding desired modes and/or display functionality, for example by way of a touch screen interface or physical buttons and switches, if desired.

Engine 18 may be an internal combustion engine configured to combust a mixture of fuel and air to produce a mechanical power output. For example, engine 18 may include a diesel engine, a gasoline engine, a gaseous fuel-powered engine, or another type of combustion engine apparent to one skilled in the art. It is contemplated, however, that engine 18 may alternatively embody a non-combustion source of power such as a fuel cell, a battery, a tether cable, or another source known in the art.

Traction devices 20, in the disclosed embodiment, are tracks located at opposing sides of machine 10. Each track may be independently driven to turn machine 10 or simultaneously and dependently driven to propel machine 10 in a straight direction. It is contemplated that one or all of traction devices 20 may be replaced with another type of traction device, if desired, such as belts or wheels. In these situations, steering of machine 10 may be implemented by pivoting and/or tilting the traction devices, as is known in the art.

As machine 10 is propelled about worksite 12 by traction devices 20, the position and/or orientation of machine 10 may be tracked by way of a locating device 26. Locating device 26 may be configured to determine a position of machine 10 and generate a signal indicative thereof. Locating device 26 could embody, for example, a global satellite system device (e.g., a GPS or GNSS device), an Inertial Reference Unit (IRU), a local tracking system, a laser range finding device, an odometric or dead-reckoning device, or any other known locating device that receives or determines positional information associated with machine 10. In some embodiments, locating device 26 may additionally include an orientation sensor such as a laser-level sensor, a tilt sensor, an inclinometer, a radio direction finder, a gyrocompass, a fluxgate compass, or another device to facilitate heading and/or inclination detection, if desired. Locating device 26 may be configured to convey a signal indicative of the received or determined positional information to one or more of interface devices 24 (e.g., to the monitor) for display of machine location in an electronic representation of worksite 12, if desired. The signal may also be directed to a controller 28 (shown only in FIG. 2) for further processing.

Work tool 22 may be supported by frame 14, powered by engine 18, and controllable and/or monitored via interface devices 24. Work tool 22 may include any device used to perform a particular task such as, for example, a bucket (shown in FIG. 1), a blade, a fork arrangement, a shovel, a dump bed, or any other task-performing device known in the art. Although connected in the embodiment of FIG. 1 to lift, pivot, and tilt relative to machine 10, work tool 22 may alternatively or additionally rotate, slide, extend, or move in another manner known in the art.

One or more sensors 30 may be associated with work tool 22 to sense one or more characteristics of material being moved by work tool 22. In the depicted example, two sensors 30a are located within work tool 22 (e.g., recessed within an internal surface of work tool 22) and embody spectrometers. As spectrometers, sensors 30a may be configured to generate one or more signals indicating constituent identities of the material being moved by work tool 22. For example, a portion of sensor 30a may be configured to expose the material to an energy source, while another portion of sensor 30 may be configured to measure the frequencies of light emitted by the material during exposure and generate corresponding signals. These signals may then be referenced with a lookup table to identify the constituents of the material. In some embodiments, the output from sensors 30a may be averaged to increase an accuracy in the identification of constituents, if desired. A translucent cover (not shown) may be associated with sensors 30a to help protect sensors 30a from abrasion by the material within work tool 22.

An additional sensor 30b may be associated with work tool 22 (e.g., mounted at an edge of work tool 22) and embody a camera. As a camera, sensor 30b may be configured to generate an image of the material being moved by work tool 22 that is representative of the material's volume. It is also contemplated that images produced by sensor 30b may be used to help determine the identification of constituents, if desired. For example, a particular color of the material, as captured in the image, may be related to particular constituents of the material.

Another sensor 30c may be associated with work tool 22 (e.g., associated with an actuator used to move work tool 22) and embody a load cell. As a load cell, sensor 30c may be configured to detect a weight of the material being moved by work tool 22, following methods that are known in the art. It is contemplated that additional and/or different sensors 30 may be associated with work tool 22, if desired.

As shown in FIG. 2, controller 28, together with interface device 24, locating device 26, and sensors 30 may constitute a site mapping system 32 configured to generate an electronic map 34 of worksite 12. Controller 28 may embody a single or multiple microprocessors, field programmable gate arrays (FPGAs), digital signal processors (DSPs), etc., that are capable of analyzing the input from locating device 26 and sensors 30 and responsively generating and updating electronic map 34 based on the analysis. Numerous commercially available microprocessors can be configured to perform the functions of controller 28. It should be appreciated that controller 28 could readily embody a microprocessor separate from that controlling other functions of machine 10 and worksite 12, or that controller 28 could be integral with a general machine and/or worksite microprocessor and be capable of controlling numerous machine and/or worksite functions and modes of operation. If a separate microprocessor, controller 28 may communicate with the general machine and/or worksite microprocessor(s) via datalinks, wireless communications, or other methods. Various other known circuits may be associated with controller 28, including power supply circuitry, signal-conditioning circuitry, actuator driver circuitry (i.e., circuitry powering solenoids, motors, or piezo actuators), and communication circuitry.

Electronic map 34 may be stored in the memory of controller 28 and selectively displayed on interface device 24. Electronic map 34 may include a collection of data in the form of tables, graphs, and/or equations. In the depicted embodiment, electronic map 34 is a three-dimensional graphical representation of worksite 12, with locations and/or concentrations of mineral deposits marked on the representation. Controller 28 may be configured to automatically generate and/or update the representation of worksite 12, including the locations and concentrations of the mineral deposits, in real time during operation of machine 10 (described in more detail in the following section). Controller 28 may also be configured to allow the operator of machine 10 to directly modify electronic map 34 and/or to select display parameters from available parameters stored in the memory of controller 28. It is contemplated that the modifications and/or display parameters may additionally or alternatively be automatically implemented and/or selectable based on modes of machine operation, if desired.

In one embodiment, controller 28 may be located onboard machine 10. In this embodiment, controller 28 may receive direct input from the locating device 26 and those sensors 30 also located onboard machine 10 and cause electronic map 34 to be displayed locally on interface device 34. It is contemplated that, in this embodiment, controller 28 may also be configured to communicate information obtained from locating device 26 and sensors 30 and/or associated with the analysis performed by controller 28 offboard machine 10 to, for example, a site base station 36 or a general site controller (not shown) located at base station 36. This information may then be analyzed at base station 36 and/or forwarded to other machines 10 operating at worksite 12. In this manner, electronic map 34 may be the compilation of data simultaneously obtained from multiple sources at multiple locations within worksite 12.

In another embodiment, controller 28 could be the general site controller located at base station 36. That is, it may be possible that the information obtained from locating device 26 and sensor 30 is only analyzed and used to generate electronic map 34 at base station 36. In this situation, electronic map 34 could then be communicated to each machine 10 operating at worksite 12. It may also be possible for controller 28 to then allocate resources of worksite 12 based on information contained in electronic map 34 to improve profitability of worksite 12. For example, controller 28 may be capable of assigning tasks to one or more machines 10 at worksite 12 to focus efforts on mineral-rich locations marked on electronic map 34.

In addition to electronic map 34, controller 28 may cause other information related to the material being moved by work tool 22 to be displayed on interface device 24. For example, controller 28 could be configured to determine a weight of the material, a volume of the material, a density of the material, a commodity price of constituents of the material, a value of the material, and other related information and cause this information to be displayed on interface device 24, if desired.

### INDUSTRIAL APPLICABILITY

The disclosed site mapping system may be applicable to any worksite and usable with any material handling machine to generate and update an electronic representation of the worksite in real time. This ability may allow for a reduction in manual surveying and sampling activities and/or for enhanced accuracy in the resulting map of the worksite. This map of the worksite, having enhanced accuracy, may be then used to increase profitability of the worksite. Operation of site mapping system 32 will now be described in detail.

During operation of machine 10, locating device 26 and sensors 30 may continuously generate signals associated with the location of machine 10 and with sensed characteristics of the material being moved by work tool 22. These signals may be directed to controller 28 for processing. Controller 28 may analyze the signals from sensors 30 and link results of the analysis to the signals received from locating device 26 at the time that the analysis is performed.

The analysis performed by controller 28 may include, among other things, identification of constituents within the material being moved by work tool 22 and determination of a volume of the material, a weight of the material, a density of the material, a concentration of particular constituents within the material, and/or a value of the material. For example, the signals from sensors 30a may be compared to one or more tables stored in memory to directly determine the identity of constituents within the material, as is known in the art. The volume of the material being moved by work tool 22 may be determined, at least in part, based on the image generated by sensor 30b. In particular, controller 28 may be configured to determine, based on the image, what portion of work tool 22 is filled by the material. Controller 28 may then be configured to calculate the volume of the material as a function of known work tool geometry and the filled portion of work tool 22. Controller 28 may be configured to directly relate the signals from sensor 30c to a weight of the material, and then determine the density of the material as a function of the calculated volume and the weight. Controller 28 may use the density information, together with the identification of constituents within the material, to determine a concentration and amount of particular constituents within the material. Based on a known market price of the particular constituents and the amount of the constituents being moved, controller 28 may then determine a value of the material (e.g., a value of each work tool load of the material). Some or all of this information may then be used to generate and update electronic map 34 and displayed on interface device 24.

It will be apparent to those skilled in the art that various modifications and variations can be made to the disclosed site mapping system. Other embodiments will be apparent to those skilled in the art from consideration of the specification and practice of the disclosed site mapping system. For example, although sensors 30 are described as being associated with work tool 22, it may be possible that sensors 30 are associated with a specialized test tool that is only used at select times. This test tool may then be selectively swapped out for a different work tool 22 that is not instrumented. In this manner, longevity of the test tool may be enhanced. It is intended that the specification and examples be considered as exemplary only, with a true scope being indicated by the following claims and their equivalents.

1. A site mapping system for use with a machine having a work tool, the site mapping system comprising:
a locating device mountable on the machine and configured to generate a first signal associated with a three-dimensional position of the machine at a site;
at least one sensor mountable on the work tool and configured to generate a second signal indicative of a characteristic of material being moved by the work tool; and
a controller in communication with the locating device and the at least one sensor, the controller being configured to:
determine a composition of the material based on the second signal; and
update an electronic map of the site based on the composition and the first signal.

2. The site mapping system of claim 1, wherein:
the at least one sensor is a spectrometer; and
the second signal is indicative of an identity of a constituent of the material being moved by the work tool.

3. The site mapping system of claim 2, wherein the at least one sensor further includes a camera configured to generate a third signal indicative of a volume of material being moved by the work tool.

4. The site mapping system of claim 3, wherein:
the at least one sensor further includes a load cell configured to generate a fourth signal indicative of a weight of the material moved by the work tool; and
the controller is further configured to determine a density of the material being moved by the work tool based on the third and fourth signals.

5. The site mapping system of claim 4, wherein the controller is further configured to determine a concentration of a particular constituent within the material being moved by the work tool based on the second signal and the density.

6. The site mapping system of claim 5, wherein the controller is further configured to determine an amount of the particular constituent within the material being moved by the work tool based on the concentration and volume of the material.

7. The site mapping system of claim 6, wherein the controller is further configured to determine a value of the particular constituent within the material being moved by the work tool based on the amount and a known market price for the particular constituent.

8. The site mapping system of claim 7, wherein the controller is further configured to allocate site resources based on the value of the particular constituent.

9. The site mapping system of claim 8, wherein the controller is a site controller in communication with multiple different machines and configured to assign tasks to the multiple different machines based on the allocated resources.

10. The site mapping system of claim 8, wherein the controller is mountable onboard the machine.

11. The site mapping system of claim 1, further including a display mountable within an operator station of the machine, wherein the controller is in communication with the display and configured to provide information regarding the electronic map to the display.

12. The site mapping system of claim 11, wherein the electronic map is three-dimensional.

13. A method executable by a processor of mapping a worksite, comprising:
determining via the processor a three-dimensional location of a machine operating at the worksite;
sensing via a sensor in communication with the processor a characteristic of material being moved by a work tool of the machine;
determining via the processor a composition of the material based on the characteristic; and
updating via the processor an electronic map of the worksite based on the composition of the material and the location of the machine.

14. The method of claim 13, wherein sensing the characteristic includes:
exposing the material being moved by the work tool to an energy source;
measuring frequencies of light emitted by the material during exposure; and
identifying constituents of the material based on the frequencies.

15. The method of claim 14, wherein:
sensing the characteristics further includes capturing an image of the material being moved by the work tool; and
the method further includes determining a volume of the material based on the image.

16. The method of claim 15, wherein:
sensing the characteristic further includes measuring a weight of the material being moved by the work tool; and
the method further includes determining a density of the material being moved by the work tool based on the volume and the weight.

17. The method of claim 16, further including determining a concentration of a particular constituent within the material being moved by the work tool based on identification of the constituents and the density.

18. The method of claim 17, further including determining an amount of the particular constituent within the material being moved by the work tool based on the concentration and volume of the material.

19. The method of claim 18, further including determining a value of the particular constituent within the material being moved by the work tool based on the amount and a known market price for the particular constituent.

20. The method of claim 19, further including allocating resources at the worksite based on the value.

21. The method of claim 13, further including displaying within an operator station of the machine information regarding the electronic map.

22. A machine, comprising:
a frame;
at least one traction device configured to support the frame and propel the machine about a worksite;
a work tool operatively connected to the frame and configured to move material at the worksite;
a locating device mounted on the frame and configured to generate a first signal associated with a three-dimensional position of the machine at the worksite;
a spectrometer mounted on the work tool and configured to generate a second signal indicative of an identity of a constituent of the material;
a camera mounted on the work tool and configured to generate an image of the material;
a display located within an operator station of the machine; and
a controller in communication with the locating device, the spectrometer, the camera, and the display, the controller being configured to:
determine a composition of the material based on the second signal;
determine a volume of the material based on the image;
update a three-dimensional electronic map of the worksite based on the composition, the volume, and the first signal; and
provide information to the display related to the three-dimensional electronic map.
